(19) United States
(12) Patent Application Publication
(10) Pub. No.: US 2022/0336915 A1
(43) Pub. Date: Oct. 20, 2022

(54) BATTERY CELL FOR A HIGH-VOLTAGE BATTERY, HIGH-VOLTAGE BATTERY AND MOTOR VEHICLE

(71) Applicant: AUDI AG, Ingolstadt (DE)

(72) Inventor: Marvin CZECH, Ingolstadt (DE)

(73) Assignee: AUDI AG, Ingolstadt (DE)

(21) Appl. No.: 17/697,274

(22) Filed: Mar. 17, 2022

(30) Foreign Application Priority Data
Apr. 20, 2021 (DE) 102021109983.8

(51) Int. Cl. H01M 50/342; H01M 50/55

(52) U.S. Cl. CPC H01M 50/3425; H01M 50/55; H01M 2220/20

(57) ABSTRACT

A battery cell for a high-voltage battery for a motor vehicle. The battery cell includes a cell housing with a first housing side. In the first housing side, a releasable degassing opening is arranged, and the battery cell includes a first and a second cell pole tap which are arranged on the first housing side. The second cell pole tap is arranged in a defined first direction between the first cell pole tap and the releasable degassing opening.

### FIELD

The invention relates to a battery cell for a high-voltage battery for a motor vehicle, wherein the battery cell comprises a cell housing with a first housing side, and wherein, in the first housing side, a releasable degassing opening is arranged, and the battery cell comprises a first and second cell pole tap, which are arranged on the first housing side. Moreover, the invention also relates to a high-voltage battery with such a battery cell and to a motor vehicle with such a high-voltage battery.

### BACKGROUND

High-voltage batteries for motor vehicles are typically formed by numerous battery cells. Said battery cells moreover can be combined in the form of a battery module. In case of failure of a battery cell, a thermal event may occur. Such a failure can occur, for example, due to a short circuit, for example, as a result of an accident of the motor vehicle. During the course of such a thermal event, a strong heating of the battery cell and extensive gas development within the battery cell occur. In order to prevent an explosion of such a battery cell, the battery cells typically have a releasable degassing opening in their cell housings. Such a gas escaping from the battery cell in case of a thermal event here includes electrically conductive particles and is moreover highly flammable. Typically, it has a high graphite content which causes the high conductivity and a large hydrogen content which results in the high flammability properties of this gas. Moreover, in prismatic battery cells it is conventional here that the cell pole taps, that is to say the cell terminals for the positive pole and the negative pole of a respective cell, hereafter in some cases also simply referred to as poles or cell poles, as well as the releasable degassing opening are arranged on the same side of the battery cell, in particular wherein here a design has been established according to which the two cell poles or cell pole taps are arranged on two facing marginal regions of this first side, and the releasable degassing opening is arranged anywhere between these poles, in particular in the region of the center between these poles. Due to the high conductivity and the easy inflammability of the gases escaping from the battery cells in case of a thermal event, it is necessary to keep the escaping gases away from the cell pole taps to the extent possible, since, due to the potential difference and the conductivity of the gases, an electrical breakdown can occur, which in turn can cause an igniting of the highly flammable gas.

Moreover, known from the prior art are cells wherein the poles and/or degassing openings are arranged on different sides of the cells. This is commonly the case in pouch cells or round cells. For example, WO 2019/230744 A1 describes a battery cell with pole lugs arranged on opposite sides and a valve arranged on a marginal region of the pouch-like battery cell. Moreover, J P 2014-209524 A describes an energy storage device with a degassing valve having a very complex design.

For example, if the poles and the degassing opening are arranged on different sides of a battery cell, this facilitates keeping the possibly escaping gases away from the cell poles in case of a thermal event. However, as a result, the production of the battery cell, particularly of the cell housing, becomes clearly more complex. Due to the additionally necessary installation space on the side in the interior of the cell, precisely in prismatic battery cells, this would moreover lead to a reduction of the maximum possible energy content of the cell.

### SUMMARY

Therefore, the problem of the present invention is to provide a battery cell, a high-voltage battery and a motor vehicle which, on the one hand, enable the most cost-effective possible design of the cell housing and, on the other hand, enable the gases escaping from the cell to be kept away from the cell pole taps as efficiently as possible, in case of a thermal event.

This problem is solved by a battery cell, a high-voltage battery cell and a motor vehicle having the features according to the respective independent claims. Advantageous embodiments of the invention are the subject matter of the dependent claims, the description and the figures.

A battery cell according to the invention for a high-voltage battery for a motor vehicle comprises a cell housing with a first housing side, wherein, in the first housing side, a releasable degassing opening is arranged, and wherein the battery cell comprises a first and a second cell pole tap which are arranged on the first housing side. Here, the second cell pole tap is arranged in a defined first direction between the first cell pole tap and the releasable degassing opening.

In other words, the degassing opening is then no longer arranged between the cell pole taps but instead the two cell pole taps are arranged on one side of the first housing side and the degassing opening is arranged on the other side of the first housing side with respect to the aforementioned defined first direction. Thereby, a clearly simpler separation of the degassing paths from the electrical poles is possible, whereby the risk of a short circuit or a flashover can be enormously reduced. However, at the same time, both cell pole taps as well as the degassing opening can be arranged on the same side of the battery cell, on the first housing side defined here. This has numerous advantages as have already been partially described at the beginning. On the one hand, it enables a particularly cost-effective design of the cell housing, since all the necessary components such as, for example, cell pole taps, the degassing opening or other optional additional components such as sensors and the like can be incorporated on the first housing side, while all the remaining cell housing sides can be provided free of any parts. For example, the cell housing thereby can be formed in a particularly simple way as a deep-drawn bowl with cover which provides the first housing side. The deep-drawn cup can thus be produced in a particularly simple and cost-effective way. In particular, by the above-described design of the battery cell according to the invention, the production method for producing conventional battery cells, in particular prismatic battery cells, can be kept with only slight modifications. In fact, for example, it is possible simply to exchange the position between a cell pole tap and the degassing opening. All the other production steps can be kept. In addition, the provision of the degassing opening on a side of the battery cells other than the side on which the cell poles are arranged would have the great disadvantage that, for the mounting of the releasable degassing opening, this would require additional installation space, particularly also mounting installation space, in the interior of the cell housing, which would reduce the maximum possible energy content of the cell with identical volume. This too can now advantageously be avoided by the battery cell according to the invention. Thus, advantageously, the invention enables one to provide a battery cell with increased safety in a particularly simple and cost-effective way.

The degassing opening can here be designed in any way, for example, as an overpressure valve. Here, it is particularly advantageous if the releasable degassing opening is formed as an opening in the cell housing, which is closed by a bursting membrane, which automatically opens or ruptures if a gas pressure in the interior of the battery cell exceeds a defined threshold value. In this case, the releasable degassing opening is formed as a simple opening such as, for example, a hole, in the first housing side, which is closed by a thin membrane, for example, a film-like membrane. This additionally enables a particularly installation space-efficient, simple, cost-effective design of such a releasable degassing opening.

Since the cell pole taps and the degassing opening are arranged on the same side of the battery cell, the individual cells can also be combined clearly more simply as cell packs or battery modules and be arranged in a mounting structure. In addition, thereby, the cells can be simply attached to a cooling device which can be arranged, for example, on the underside, that is to say facing the first housing side.

Moreover, it is preferable that the first housing side defines an upper side of the battery cell. Here, this relates to an installation position according to the intended purpose of the battery cell in the high-voltage battery or in the motor vehicle. Since the degassing opening is consequently also located on the upper side, in case of a thermal event, a reliable opening of the degassing opening and an efficient discharge of the gases can be assumed. This is the result of the hot gases rising upward, whereby escape of such gases from an opening lying on top is facilitated in comparison to a degassing opening arranged on the side or on the underside for example.

The cell housing is designed to be relatively dimensionally relatively stable, in particular in comparison to the pouch-like structure of typical pouch cells. In other words, the cell housing is preferably a so-called hard case. Preferably, the battery cell is designed as a prismatic cell. This means that the cell housing has a substantially prismatic geometry. This can also include embodiments in which, for example, a pouch cell is incorporated in a hard case, that is to say a relatively dimensionally stable cell housing, such as, for example, the housing of a prismatic cell.

Furthermore, it is advantageous if the first housing side is designed as a rigid housing cover of the cell housing. Thereby, various components such as, for example, the mentioned cell pole taps and the degassing opening can be incorporated in a particularly simple, stable and reliable way.

In an additional advantageous embodiment of the invention, the cell housing comprises a housing bottom part different from the first housing side, which different part comprises a second side arranged facing the first side, a third and fourth side, which face one another, and a fifth and sixth side, which face one another, wherein the housing bottom part is designed as one piece, in particular as a deep-drawn component. For example, the housing bottom part can be designed as a simple, metallic, deep-drawn cup, as mentioned at the beginning, made of aluminum, for example, and the first housing side can be placed as a cover on this cup. In the interior of the cup, accordingly, the cell chemistry can be arranged, such as, for example, a cell coil with electrolyte. This allows a particularly simple and cost-effective design of the battery cell.

In an additional highly advantageous embodiment of the invention, a distance of the releasable degassing opening in the first direction from a margin of the first housing side is less than or equal to a distance from a center of the first housing side. The farther the releasable degassing opening is located on the margin of the first housing side, the greater the spacing from the cell pole taps is and the simpler the separation of the degassing paths from the electrical poles can be designed. In order to promote this separation, between the releasable degassing opening and the cell pole taps, a separation element can also be arranged on the first housing side between the releasable degassing opening and the cell pole taps. Such a separation element can be designed, for example, as a simple web. But the releasable degassing opening can also be connected to a degassing duct which at least partially covers the degassing opening or into which the degassing opening leads. The wall of such a duct thus separates the corresponding degassing path from the electrical poles.

Here, it is particularly advantageous if the battery cell comprises a hood arranged on the first housing side in the region of the releasable degassing opening and which is designed to divert gas escaping from the degassing opening, in particular, with respect to the first direction, away from the first and second cell pole taps. By means of such a hood, it is thus possible to provide simultaneously in a particularly efficient way a separation from the cell pole taps as well as a diversion of gas away from these cell pole taps. For example, such a hood can lead the gas to be discharged in a targeted way into a gas duct or the like. Besides the fact that such a hood enables a diversion of gas away from the cell pole taps, this entails another very great advantage: For example, a lateral guiding of the gas flow can be provided, that is to say a guiding which is not directed upward. Typically high-voltage batteries in motor vehicles are arranged in the undercarriage region of the motor vehicle, that is to say under a passenger compartment. Gases escaping upward out from the battery cells are here automatically directed in direction of the passenger space. This can then advantageously be prevented by the described hood and its gas diversion function. It is precisely when the hot escaping gases in addition catch fire that additional protection for passengers in the interior can be provided by the lateral diversion.

The invention further relates to a high-voltage battery for a motor vehicle with a battery cell according to the invention or one of its embodiments. The advantages described for the battery cells according to the invention and their embodiments thus apply likewise to the high-voltage battery according to the invention. Preferably, such a high-voltage battery comprises multiple batteries of this type.

Here, it is moreover particularly advantageous if the high-voltage battery comprises a first cell row with multiple first battery cells of the battery cells and a second cell row with multiple second battery cells of the battery cells. The first and second battery cells thus are designed as battery cells according to the invention or as battery cells according to embodiments of the invention. Moreover, it is preferable that the first and second cell rows are arranged running parallel to one another in a second direction perpendicular to the first direction, wherein, with regard to a position of the first and second cell pole taps and the releasable degassing opening, the first housing sides of the first battery cells are designed mirror symmetrically relative to the first housing sides of the second battery cell with respect to a plane of mirror symmetry running perpendicularly to the first direction. In this way, advantageously, the distance of the degassing openings from cell rows adjacent to the cell pole taps can be maximized.

According to an additional highly advantageous embodiment of the invention, the releasable degassing openings of the first cell row are father apart. from the releasable degassing openings of the second cell row in the first direction than the first and second cell pole taps of the first cell row are from those of the second cell row. In other words, the releasable degassing openings are arranged on the outside, and the cell pole taps of the respective cell rows are arranged in a central region of the cell arrangement. This facilitates a discharge of the escaping gases to the outside, in particular out of the high-voltage battery and of the vehicle. In addition, thereby, it can be achieved that degassing ducts are arranged on the outside with respect to this cell arrangement of the high-voltage battery, ducts which, for example, can also run parallel to the cell rows and to which the releasable degassing openings accordingly can be connected in a particularly simple way, due to their respective positioning in the marginal region of the cell arrangement. The cell pole taps, on the other hand, are located in a central region of the cell arrangement of the high-voltage battery. Accordingly, the interconnection of the cells and the high-voltage lines can be arranged there. As a result, the separation of the degassing paths from the high-voltage components is particularly efficient. The safety can thereby be maximized accordingly.

Nonetheless, it would also be conceivable that the degassing openings are arranged in a central region close to the plane of mirror symmetry and the cell pole taps are instead arranged on the outside. This enables, for example, a central gas discharge through a centrally running gas duct out of the battery and out of the vehicle. In this case, a particularly efficient separation between the degassing paths and the cell pole taps and other high-voltage components is provided.

The invention further relates to a motor vehicle with a high-voltage battery according to the invention or one of its embodiments. The advantages described for the high-voltage battery according to the invention and its embodiments apply in the same way to the motor vehicle according to the invention. Here, it is preferable if the first housing side of the battery cell defines an upper side with respect to an installation position according to the intended use of the high-voltage battery in the motor vehicle. In addition, the first direction can correspond, for example, to a vehicle transverse direction, and the second direction can correspond to a vehicle longitudinal direction. However, other embodiments are also conceivable.

For example, the first and second cell rows can represent the only the cell rows that the high-voltage battery includes. This is particularly advantageous, since the decoupling of the degassing paths from the cell pole taps is considerably facilitated, thereby. The battery cells can accordingly be designed to be wide with respect to the vehicle transverse direction, in order to maximally fill the installation space available there with the two cell rows.

The motor vehicle according to the invention is preferably designed as an automobile, in particular as a passenger car or a truck, or as a minibus or a motorcycle.

The invention also includes the combinations of the features of the described embodiments. The invention also includes embodiments which each have a combination of the features of a number of the described embodiments, to the extent that the embodiments were not described as mutually exclusive.

### BRIEF DESCRIPTION OF THE DRAWINGS

Below, embodiment examples of the invention are described. The figures show:

FIG. 1 a diagrammatic representation of a battery cell in a side view according to an example which is not part of the invention;

FIG. 2 a diagrammatic representation of the battery cell from FIG. 1 in a top view;

FIG. 3 a diagrammatic representation of a prismatic battery cell in a side view according to an embodiment of the invention;

FIG. 4 a diagrammatic representation of the battery cell from FIG. 3 in a top view; and

FIG. 5 a diagrammatic representation of a motor vehicle with a high-voltage battery and multiple battery cells according to an embodiment example of the invention.

### DETAILED DESCRIPTION

The embodiment examples explained below are preferred embodiments of the invention. In the embodiment examples, the described components of the embodiments each represent individual features of the invention, which are to be considered independently of one another, and which also further develop the invention independently of one another. Therefore, the disclosure is also intended to include combinations of the features of the embodiment other than those represented. Moreover, the described embodiments can also be completed by additional already described features of the invention.

In the figures, identical reference numerals denote respective functionally equivalent elements.

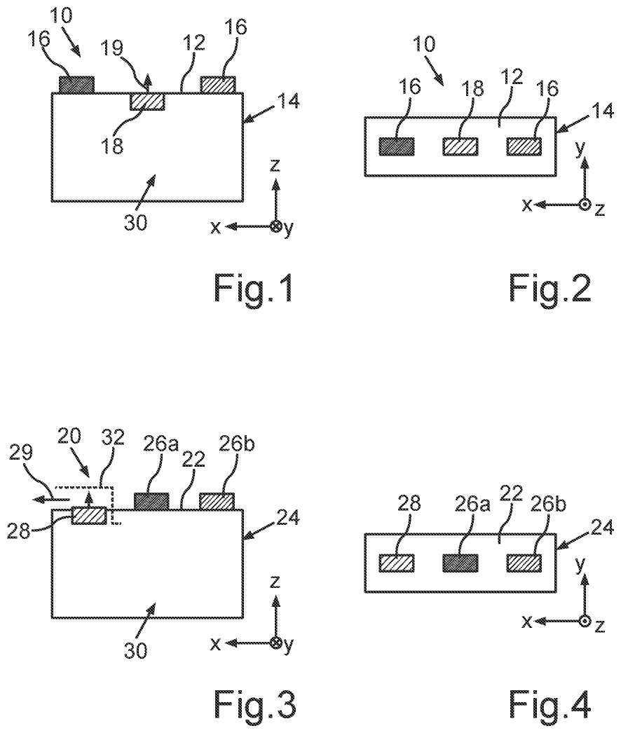

FIG. 1 shows a diagrammatic representation of a battery cell 10 in a side view according to an example which is not part of the invention, and FIG. 2 shows a diagrammatic representation of this battery cell 10 in a top view from above onto a first housing side 12 of a cell housing 14 of this battery cell 10. The battery cell 10 here is designed as conventional prismatic battery cell 10 and comprises two cell poles 16 of which one is designed as positive pole and one as negative pole. Here, these two cell poles 16 together with a degassing opening 18 are arranged on the upper side 12 of the cell housing 14. In case of a thermal event, gases 19 can be discharged from the cell housing 14 through the degassing opening 18. However, if this degassing opening is arranged as represented in FIG. 1 and FIG. 2 between the cell poles 16, then the separation of the degassing paths from the electrical poles 16 becomes very difficult. This can advantageously be avoided by an asymmetric arrangement of the degassing opening with respect to the cell poles, as will be described below in reference to embodiment examples of the invention.

FIG. 3 here shows a diagrammatic representation of a battery cell 20 in a side view according to an embodiment example of the invention, and FIG. 4 shows a diagrammatic representation of this battery cell 20 in a top view from above onto a first cell housing side 22 of a cell housing 24. In this example, the battery cell 20 is designed as prismatic battery cell 20. The first housing side 22 here defines an upper side 22 of the battery cell 20 with respect to an installation position according to the intended use of the battery cell 20 in a motor vehicle. This battery cell 20 comprises two cell pole taps 26a, 26b. One of these two cell pole taps 26a, 26b can here be designed as positive pole and the other as negative pole. For example, in this example, the first cell pole tap 26a can be designed as negative pole and the second cell pole tap 26b as positive pole or vice versa. The two cell pole taps 26a, 26b are here arranged on the first cell housing side 22. The cell housing side 22 moreover comprises a releasable degassing opening 28. This degassing opening is designed to release and thereby enable an escape of gases 29, in case of a thermal event or at least overpressure within the cell housing 24. The releasable degassing opening 28 can be designed, for example, as an opening which is closed by a gas membrane. This opening 28 is also accordingly located in the upper side 22 of the cell housing 24. Advantageously, this degassing opening 28 is then no longer arranged between the two cell pole taps 26a, 26b but instead one of the two cell pole taps, in this example the first cell pole tap 26a, is arranged between the degassing opening 28 and the second cell pole tap 26b. This clearly facilitates the separation of the degassing paths from the electrical poles 26a, 26b. Advantageously, at the same time, this can also reduce the risk of a short circuit or a flashover during the degassing of the battery cell 20. The safety can overall be increased. At the same time, this enables a very simple and cost-effective design of the battery cell 20, in particular of the cell housing 24, since moreover all the components of the cell housing 24, such as the cell poles 26a, 26b, the degassing opening 28 and additional optional components, are arranged on the same side, namely the first housing side 22. The remaining sides of the cell housing 24, which provide a housing bottom part 30, can be cost-effectively produced, for example, as a deep-drawn cup. The upper side 22 can simply be placed as cover on this cup 30. By means of the eccentric arrangement of the releasable degassing opening 28, it is moreover possible for escaping gases 29 to be discharged, for example, not upward but laterally with respect to the cell 20. This provides considerably more flexibility with respect to the gas flow management. For example, the battery cell 20, as illustrated diagrammatically in FIG. 3, can also comprise a hood 32 which is also arranged on the upper side 22 of the cell housing 24, in particular in the region of the releasable degassing opening 28, and which is designed to divert the escaping gas 29, in particular away from the cell poles 26a, 26b.

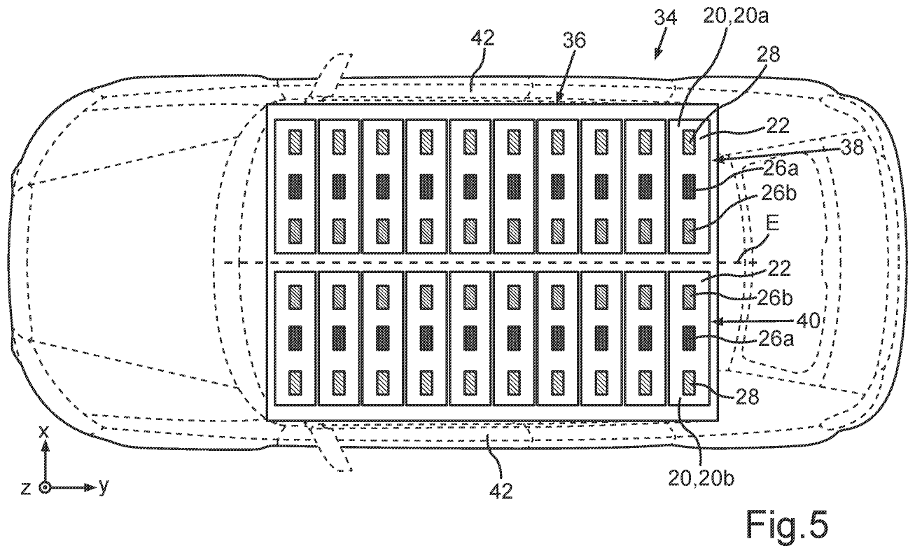

FIG. 5 shows a diagrammatic representation of a motor vehicle 34 with a high-voltage battery 36 according to an embodiment example of the invention. The high-voltage battery 36 here includes numerous battery cells 20 which can be designed as described above. In this example, the high-voltage battery 36 includes a first cell row 38 with multiple such battery cells 20 referred to in the present case as 20a, and a second cell row 40 with multiple second battery cells 20 referred to in the present case as 20b. The two cell rows 38, 40 here run parallel to one another in vehicle longitudinal direction which here corresponds to the y direction. The first and second battery cells 20a, 20b of the respective cell rows 38, 40 are arranged next to one another in accordance with the vehicle longitudinal direction y. Here, it is particularly advantageous if, with regard to the positioning of their cell pole taps 26a, 26b and the releasable degassing openings 28, the battery cells 20a are arranged mirror symmetrically with respect to those of the second battery cells 20b of the second cell row 40. This makes it possible to decouple the degassing paths from the electrical high-voltage components in an even more efficient way. It is moreover particularly advantageous here if the degassing openings 28 are arranged on the outside, for example, with respect to a center axis running in vehicle longitudinal direction. This can simultaneously represent the axis of mirror symmetry axis. A corresponding plane of mirror symmetry in the present case is denoted E and runs perpendicularly to the represented x-direction. Thus, the escaping gases 29 can be discharged particularly simply to the outside, for example, via respective lateral side skirt regions 42 of the motor vehicle 34. For the sake of clarity, in FIG. 5, for the cell rows 38, 40, in each case only one battery cell 20a, 20b, its cell poles 26a, 26b and its degassing opening 28 in the upper side 22 are provided with a reference numeral. Moreover, in the present example, the two cell poles 26a, 26b of the respective first and second battery cells 20a, 20b are also arranged mirror symmetrically with respect to one another, although this does not necessarily have to be the case. In other words, in this example, it does not matter which of the two poles 26a, 26b is located in the region of the center of the respective upper side 22 and which one is located in a marginal region.

Overall, the examples show how, by means of the invention, an asymmetric battery cell can be provided, which, due to the asymmetric arrangement of a releasable degassing opening with respect to the cell poles of a prismatic battery cell, makes it possible to clearly facilitate the separation of the degassing paths from the electrical poles without thereby complicating the setup and the design of such a battery cell.

1. A battery cell for a high-voltage battery for a motor vehicle, comprising: a cell housing with a first housing side, wherein, in the first housing side, a releasable degassing opening is arranged, and wherein the battery cell includes a first and a second cell pole tap which are arranged on the first housing side,
wherein
the second cell pole tap is arranged in a defined first direction between the first cell pole tap and the releasable degassing opening.

2. The battery cell according to claim 1, the battery cell is designed as a prismatic cell.

3. The battery according to claim 1, wherein the first housing side is designed as a rigid housing cover of the cell housing.

4. The battery cell according to claim 1, wherein the cell housing includes a housing bottom part different from the first housing side, which different part includes a second side which is arranged facing the first housing side, a third and fourth side which face one another, and a fifth and sixth side, which face one another, wherein the housing bottom part is designed as one piece, in particular as deep-drawn component.

5. The battery cell according to claim 1, wherein a distance of the releasable degassing opening in the first direction from a margin of the first housing side is less than or equal to a distance from a center of the first housing side.

6. The battery cell according to claim 1, wherein the battery cell comprises a hood which is arranged on the first housing side in the region of the releasable degassing opening and which is designed to divert a gas escaping from the degassing opening, in particular, with respect to the first direction, away from the first and second cell terminal taps.

7. A high-voltage battery for a motor vehicle with a battery cell wherein the battery cell includes:
a cell housing with a first housing side, wherein, in the first housing side, a releasable degassing opening is arranged, and wherein the battery cell includes a first and a second cell pole tap which are arranged on the first housing side, wherein the second cell pole tap is arranged in a defined first direction between the first cell pole tap and the releasable degassing opening.

8. The high-voltage battery according to claim 7, wherein the high-voltage battery comprises a first cell row with multiple first battery cells of the battery cells and a second cell row with multiple second battery cells of the battery cells, wherein the first and second cell rows are arranged running parallel to one another in a second direction perpendicular to the first direction, wherein the first housing sides of the first battery cells, with regard to a position of the first and second cell pole taps and the releasable degassing opening, are designed mirror symmetrically relative to the first housing sides of the second battery cells with respect to a plane of mirror symmetry running perpendicularly to the first direction.

9. The high-voltage battery according to claim 8, wherein the releasable degassing openings of the first cell row are farther apart from the releasable degassing openings of the second cell row in the first direction than the first and second cell pole taps of the first cell row are from those of the second cell row.

10. A motor vehicle with a high-voltage battery with a battery cell wherein the battery cell includes:
a cell housing with a first housing side, wherein, in the first housing side, a releasable degassing opening is arranged, and wherein the battery cell includes a first and a second cell pole tap which are arranged on the first housing side, wherein the second cell pole tap is arranged in a defined first direction between the first cell pole tap and the releasable degassing opening.

11. The battery according to claim 2, wherein the first housing side is designed as a rigid housing cover of the cell housing.

12. The battery cell according to claim 2, wherein the cell housing includes a housing bottom part different from the first housing side, which different part includes a second side which is arranged facing the first housing side, a third and fourth side which face one another, and a fifth and sixth side, which face one another, wherein the housing bottom part is designed as one piece, in particular as deep-drawn component.

13. The battery cell according to claim 3, wherein the cell housing includes a housing bottom part different from the first housing side, which different part includes a second side which is arranged facing the first housing side, a third and fourth side which face one another, and a fifth and sixth side, which face one another, wherein the housing bottom part is designed as one piece, in particular as deep-drawn component.

14. The battery cell according to claim 2, wherein a distance of the releasable degassing opening in the first direction from a margin of the first housing side is less than or equal to a distance from a center of the first housing side.

15. The battery cell according to claim 3, wherein a distance of the releasable degassing opening in the first direction from a margin of the first housing side is less than or equal to a distance from a center of the first housing side.

16. The battery cell according to claim 4, wherein a distance of the releasable degassing opening in the first direction from a margin of the first housing side is less than or equal to a distance from a center of the first housing side.

17. The battery cell according to claim 2, wherein the battery cell comprises a hood which is arranged on the first housing side in the region of the releasable degassing opening and which is designed to divert a gas escaping from the degassing opening, in particular, with respect to the first direction, away from the first and second cell terminal taps.

18. The battery cell according to claim 3, wherein the battery cell comprises a hood which is arranged on the first housing side in the region of the releasable degassing opening and which is designed to divert a gas escaping from the degassing opening, in particular, with respect to the first direction, away from the first and second cell terminal taps.

19. The battery cell according to claim 4, wherein the battery cell comprises a hood which is arranged on the first housing side in the region of the releasable degassing opening and which is designed to divert a gas escaping from the degassing opening, in particular, with respect to the first direction, away from the first and second cell terminal taps.

20. The battery cell according to claim 5, wherein the battery cell comprises a hood which is arranged on the first housing side in the region of the releasable degassing opening and which is designed to divert a gas escaping from the degassing opening, in particular, with respect to the first direction, away from the first and second cell terminal taps.
